(19) United States
(12) Patent Application Publication
(10) Pub. No.: US 2020/0062326 A1
(43) Pub. Date: Feb. 27, 2020

(54) CANOPY ASSEMBLY FOR BICYCLES AND SIMILAR EQUIPMENT

(71) Applicant: 1 Badass Canopy LLC, Troy, MI (US)

(72) Inventor: Bruce Darga, Troy, MI (US)

(21) Appl. No.: 16/673,762

(22) Filed: Nov. 4, 2019

Related U.S. Application Data
(63) Continuation of application No. 16/432,777, filed on Jun. 5, 2019.
(60) Provisional application No. 62/681,217, filed on Jun. 6, 2018.

(51) Int. Cl. B62J 17/08; B62J 6/00

(52) U.S. Cl. CPC B62J 17/08; B62J 2017/083; B62J 6/00

(57) ABSTRACT

A canopy assembly adapted for interconnection to a wheeled vehicle and configured to be positioned over an operator of the vehicle. The canopy is tensioned to create a bowed configuration over an operator's head. The canopy is particularly suited for interconnection to a bicycle wherein the canopy is supported and tensioned with spreader bars, rods, and torsion rods that are interconnected at the front and rear of the bicycle.

This application is a continuation of U.S. patent application Ser. No. 16/432,777 filed on Jun. 5, 2019. This application also claims benefit of U.S. Provisional Patent Application Ser. No. 62/681,217, filed Jun. 6, 2018. These applications are both incorporated by reference herein in their entireties.

### FIELD

Embodiments of the present invention generally relate to bicycle accessories, and more specifically to a canopy assembly for connection to and use with bicycles and other wheeled vehicles. Methods for making and using the assembly are also disclosed herein.

### BACKGROUND

A variety of devices are used for attachment to bicycles, tricycles, recombinant trikes, and the like, including reflectors, headlights, taillights, seat cushions, bottle carriers, speedometers, GPS systems, mobile device holder, and other accessories. Typically, such attachments are rigid and primarily designed to ensure the attachment (e.g., a bottle carrier), or alternatively, some article carried by the attachment (e.g., a water bottle), remain secured to the bicycle when it is in use. These prior art devices are generally suited for coupling to the bicycle frame, handlebars, or seat assembly.

Prior art devices suffer from significant disadvantages, particularly in regard to attaching a canopy or equivalent shading apparatus that protects a rider from sun exposure or other weather elements. For example, prior art canopies devices are often cumbersome and difficult to attach. Other disadvantages include ineffective coverage, poor stability/flexibility, subsidence, impaired usability, and impaired visibility. Prior art devices are also incompatible with several different models of cycling equipment and are not easily adaptable to different frame, handlebar, and seat styles and positions.

Therefore, it would be advantageous to provide an assembly that may be attached to a variety of bicycles and similar equipment that significantly reduces, if not eliminates, the shortcomings and problems noted above. Those of ordinary skill in the art will appreciate additional advantages over the prior art upon review of the Summary and Detailed Description sections provided below.

### SUMMARY

The various embodiments of the present invention discussed herein provide a canopy assembly for shading and protecting a cyclist. The contemplated canopy assembly may be attached to and adjustable relative to a wheeled vehicle, such as a bicycle, recumbent tricycle, or tricycle, or accessories interconnected thereto. One of ordinary skill in the art will appreciate the use of the term “bicycle” herein is not restrictive and, in most instances, the applicability of features/aspects of the embodiments of the present invention discussed below will be equally suited with respect to other devices, such as kayaks and tricycles, for example. The canopy assembly of one embodiment of the present invention is designed to bend over a portion of the bicycle, wherein the canopy is held taut by spreader bars positioned on front and rear ends thereof. Lateral rods, which are associated with lateral edges of the canopy, are used to interconnect the front spreader bar to the rear spreader bar. The front spreader bar and the rear spreader bar are interconnected to at least one respective front and rear torsion bars that are interconnected on opposite ends to respective front and rear mounts interconnected to the bicycle. In operation, the lateral rods, front torsion bar(s), and rear torsion bar(s) flex in such a way to bow and tension the canopy along its longitudinal and transverse axes. Some embodiments of the present invention employ a single front torsion bar, while other embodiments employ a plurality of cables, for example, to maintain the desired canopy configuration.

It is one aspect of some embodiments of the present invention to provide a canopy assembly that does not obstruct or otherwise interfere with cyclist visibility. It is another related aspect of some embodiments of the present invention to provide a protective canopy that provides shade and UV protection to the cyclists. The canopy assembly provides more than adequate clearance to the cyclist, regardless of their height, without creating excessive drag or exacerbating wind shear when the bicycle is operated at higher speeds. The canopy of one embodiment of the present invention is comprised of a ripstop, nylon material, which may perforated. The canopy may have double stitched sleeves that forms the desired shape.

It is yet another aspect of some embodiments of the present invention to provide a canopy assembly that is relatively easy to install and uninstall, store, and transport. The contemplated canopy also provides a secure and stable connection to the bicycle, wherein the canopy is tensioned to avoid significant displacements while cycling.

Some embodiments of the present invention include lighting elements, such as light emitting diodes (LEDs), to improve visibility of the canopy assembly and, thus, the bicycle. The lighting elements provide elimination, thus, functions as a safety feature by increasing the cyclist's visual footprint. The contemplated lighting elements may also be used to illuminate the cyclist's path. In one embodiment, the contemplated lighting elements are integrated into the front and/or rear spreader bars. One of ordinary skill in the art will appreciate that lighting elements may also be incorporated into the front/rear torsion bars and the lateral rods. As will be discussed in further detail below, lighting elements of one embodiment of the present invention are incorporated into the canopy. The lighting elements employed by some embodiments of the present invention are powered by batteries integrated into the front spreader bar, rear spreader bar, the front mount, and/or the rear mount. Light illumination, intensity, etc. may be controlled by controls integrated into the canopy assembly or by an application on the cyclist's mobile device. In some embodiments of the present invention, lights associated with the rear spreader bar or rear torsion bars are controlled by switches associated with the handlebars, wherein selective illumination functions as a turn signal, i.e., blinkers. The front/rear spreader bars and front/rear torsion bars may be hollow or semi-hollow to allow for wiring for the contemplated lighting elements to be concealed.

It is yet another aspect of some embodiments of the present invention to provide a canopy that can be used for artistic or advertising purposes. More specifically, the canopy may employ a plurality of LEDs configured to emit steady or variable single or multicolored light. Alternatively, the canopy may receive a flexible light emitting member. The lights may be selectively controllable such that one or more lights appear as text or other indicia, which can be used for advertising. The advertising, or other information, may be viewable from either side of the canopy or both sides of the canopy.

The controller and LED power source may be integrated into any of the components described above, such as the front/rear spreader bars or the front/rear mounts. The user interface can be provided via the cyclist's mobile device that communicates wirelessly with the controller. Further, the GPS system of the cyclist's mobile device, for example, could be used to alter the advertising as a function of geographic location. This contemplated functionality allows the advertising content to change as the cyclist moves from one location to another automatically. In one embodiment, the information displayed to the rider/passenger includes location information, radio channel information, weather information, etc. One of ordinary skill in the art will appreciate that these latter features would be ideal for pedicab operators that would use such functionality to advertise their availability to accept passengers, to indicate they are out of service, or to simply provide a more exciting experience to their clients. For example, the lights may be integrated with an audio device associated with the bicycle, wherein the character and intensity of lights alter in conjunction with audio output. Pedicab operators could use the advertising functionality to obtain additional revenue.

In some embodiments of the present invention, a rear canopy is provided between the rear torsion bars. The rear canopy's primary purpose is to keep mud or water off the cyclist's back. The rear canopy can be clear, opaque, or semi-opaque. In some embodiments, the rear canopy employs a plurality of selectively controllable light emitting elements as described above. In still further embodiments, side canopies are provided between at least a portion of a lateral rod(s) and a portion of a rear torsion bar(s). The side canopies could be opaque, semi-opaque, or include windows. Again, the side canopies can be included with indicia, lights, or combination thereof.

It is another aspect of some embodiments the present invention to provide a canopy system that is easily storable. More specifically, in some embodiments of the present invention, the front and rear torsion bars are segmented, foldable, or telescoping, such that they can be quickly reduced in length. Thereafter, they can be rolled into the canopy to and stored. Those of ordinary skill in the art will appreciate that this functionality is also ideal to prevent theft.

It is yet another aspect of one embodiment of the present invention to provide a canopy system, comprising: an opaque or semi-opaque member having a front edge, a rear edge, a first lateral edge, and a second lateral edge, the first lateral edge and the second lateral edge interconnecting the front edge to the rear edge; a first lateral rod interconnected to the first lateral edge; a second lateral rod interconnected to the second lateral edge; a front spreader bar associated with the front edge; a second spreader bar associated with the rear edge, the front spreader bar and the second spreader bar configured to receive ends of the first lateral rod and the second lateral rod, which is configured to tension the member along a transverse axis thereof; a front mount adapted to interconnect to a handle bar stem of a bike, the clamp having a first receiver; a rear mount interconnected to a clamp configured to interconnect to a block with a portion of a rear bike rack therebetween, the rear mount having a second receiver and a third receiver; a front torsion member interconnecting the front spreader bar to the first receiver; a first rear torsion bar interconnecting the rear spreader bar to the second receiver; a second rear torsion bar interconnecting the rear spreader bar to the third receiver; and wherein the front torsion member, the first rear torsion bar, and the second rear torsion member are configured to tension the member generally along a longitudinal axis thereof.

It is yet another aspect of some embodiments of the present invention to provide a canopy system, comprising: a member having a front edge, a rear edge, a first lateral edge, and a second lateral edge, the first lateral edge and the second lateral edge interconnecting the front edge to the rear edge; a first lateral rod interconnected to the first lateral edge; a second lateral rod interconnected to the second lateral edge; a front spreader bar associated with the front edge; a second spreader bar associated with the rear edge, the front spreader bar and the second spreader bar configured to receive ends of the first lateral rod and the second lateral rod; a front mount adapted to interconnect to a handle bar stem having a first receiver; a rear mount adapted to interconnect to a to a block with a portion of a rear bike rack therebetween, the rear mount having a second receiver and a third receiver; a front torsion bar interconnecting the front spreader bar to the first receiver; a first rear torsion bar interconnecting the rear spreader bar to the second receiver; and a second rear torsion bar interconnecting the rear spreader bar to the third receiver.

The Summary of the Invention is neither intended nor should it be construed as being representative of the full extent and scope of the present invention. That is, these and other aspects and advantages will be apparent from the disclosure of the invention(s) described herein. Further, the above-described embodiments, aspects, objectives, and configurations are neither complete nor exhaustive. As will be appreciated, other embodiments of the invention are possible using, alone or in combination, one or more of the features set forth above or described below. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present invention are possible utilizing, alone or in combination, as set forth above and/or described in the accompanying figures and/or in the description.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and drawing figures are to be understood as being approximations which may be modified in all instances as required for a particular application of the novel assembly and method described herein.

It is expressly understood that where the term “cycling equipment” and “bicycle” is used herein to describe the type of equipment the assembly may be attached to. However, those terms should not be construed as limiting in any way. For instance, the subject of the present invention could be attached to other equipment, such as a snowmobile, a riding lawnmower, a stroller, a carriage, a wagon, a sled, a scooter, a hovercraft (i.e., a Segway®), or other equipment typically ridden by one or more persons. The assemblies and methods described herein may be applied to other types of equipment without significant modification, and without departing from the spirit of the present invention.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description and in the appended drawing figures.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a side elevation view of a canopy assembly of one embodiment of the present invention interconnected to a bicycle;

FIG. 2 is a perspective view of FIG. 1;

FIG. 3 is a detailed view showing a front portion of the canopy assembly;

FIG. 4 is a detail view showing a rear portion of the canopy assembly;

FIG. 5 is a detail view showing a rear mount of one embodiment of the present invention;

FIG. 6 is a rear elevation view of the rear mount;

FIG. 7 is a top plan view of a front mount of one embodiment of the present invention;

FIG. 8 includes a front elevation and top plan view of the canopy assembly;

FIG. 9 is a detailed view showing a front portion of the canopy assembly in an alternate embodiment;

FIG. 10 is a partial plan view of the embodiment of FIG. 9; and

FIG. 11 includes multiple top plan views of the embodiment of FIG. 9.

The following component list and associated numbering found in the drawings is provided to assist in the understanding of one embodiment of the present invention:

| # | Component |
|---|---|
| 2 | Bicycle |
| 6 | Canopy |
| 10 | Lateral rod |
| 14 | Front spreader bar |
| 18 | Rear spreader bar |
| 22 | Front edge |
| 26 | Tensioner |
| 30 | Rear edge |
| 34 | Longitudinal axis |
| 38 | Transverse axis |
| 42 | Front torsion bar |
| 46 | Rear torsion bar |
| 50 | Bushing block |
| 54 | Front mount |
| 58 | Handlebar stem |
| 62 | Rear mount |
| 70 | Front tension rod |
| 74 | Rear tension rod |
| 80 | Rear rack |
| 84 | Rack support member |
| 88 | Block |
| 92 | Clamp block |
| 96 | Fastener |
| 100 | Knob |
| 104 | Bracket Reflective surface |
| 106 | Rack Reflective Surface |
| 108 | Receiver |
| 112 | Screw |
| 116 | Flag post |
| 120 | Knob |
| 130 | Clamp block |
| 134 | Receiver |
| 138 | Knob/Thumb Screw |
| 142 | Reduction Ferrule |
| 146 | Spreader Bar End Cap |
| 150 | Cap |
| 154 | Retainer Washer |
| 158 | Thrust Washer |
| 162 | Graphite Bushing |
| 166 | Cap |
| 170 | Insert |
| 174 | Bonded Insert |
| 176 | Threaded Insert |
| 182 | Nylon Insert |
| 186 | Self-Locking Nut |
| 190 | Washer |
| 194 | Dowel |
| 200 | Front Spreader Bar |
| 204 | Upper Flex Joint |
| 208 | Front Rod |
| 212 | Lower Flex Coupler |
| 216 | Carabineer |
| 220 | Bolt |
| 224 | Cap |
| 228 | Expandable Nut |
| 234 | Sleeve |
| 236 | Cap |
| 240 | Derailleur Stub |
| 300 | Diode Strip |
| 340 | Power Supply/Controller |
| 400 | Diode Strip |
| 440 | Power Supply/Controller |
| 500 | Diode Strip |

It should be understood that the drawings are not necessarily to scale. In certain instances, details which are not necessary for an understanding of the invention or which render other details difficult to perceive may have been omitted. It should be understood, of course, that the invention is not necessarily limited to the particular embodiments illustrated herein.

### DETAILED DESCRIPTION

It is Applicant's intent that this specification and the inventions described herein be accorded a breadth in keeping with the scope and spirit of the disclosure and various embodiments disclosed, despite what might appear to be limiting language imposed by certain examples described in detail below. To acquaint persons skilled in the pertinent arts most closely related to the present invention, preferred and/or exemplary embodiments are described in detail without attempting to describe all of the various forms and modifications in which the novel assembly, apparatus, components, devices, systems, and methods might be embodied. As such, the embodiments described herein are illustrative, and as will become apparent to those skilled in the arts, may be modified in numerous ways within the spirit of the disclosure.

By way of providing additional background, context, and to further satisfy the written description requirements of 35 U.S.C. § 112, the following are incorporated by reference in their entireties for the express purpose of explaining and further describing the various types of equipment that may be used with the assembly and method described herein: U.S. Patent Application Publication Nos. 2018/0057113 and 2018/0072164.

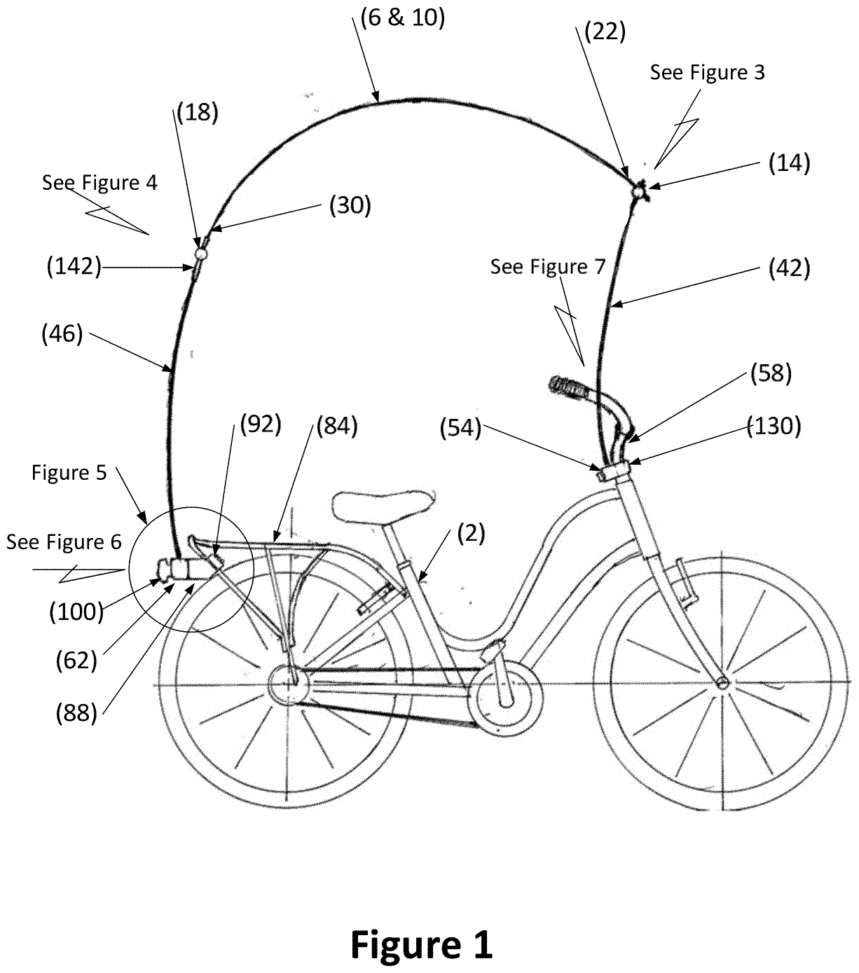

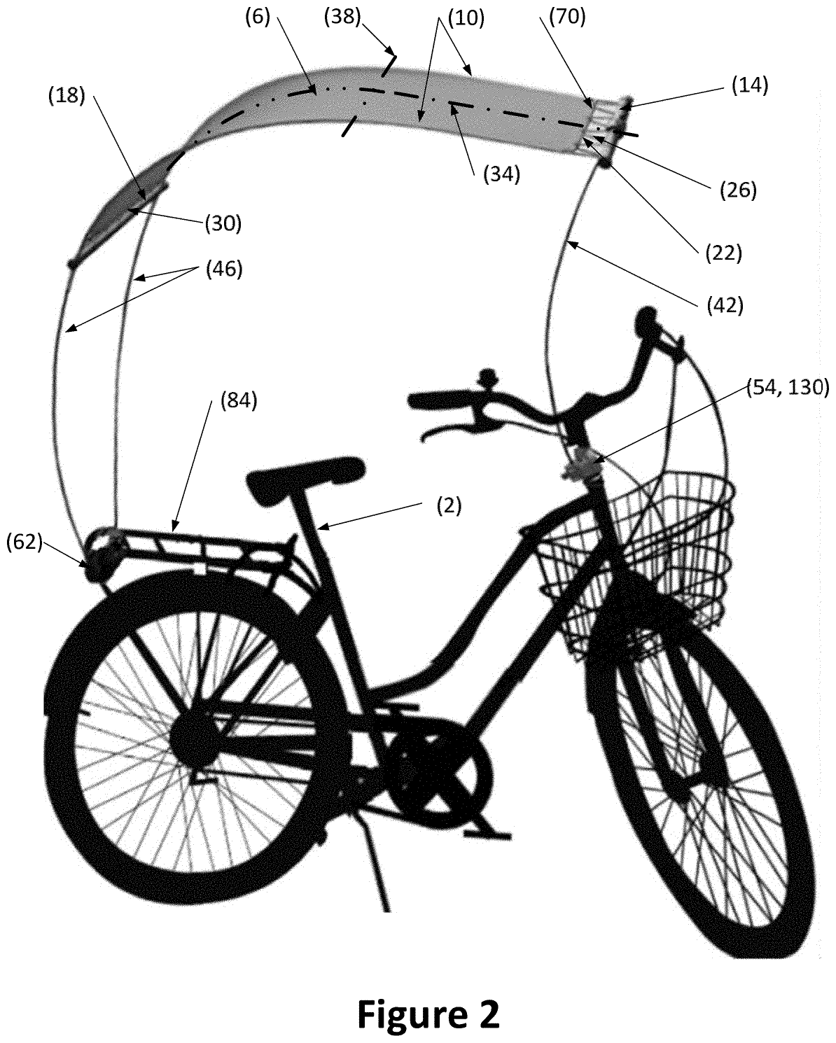

FIGS. 1-11 show a canopy assembly adapted for interconnection to a wheeled vehicle, such as a bicycle 2 or recombinant trike. Referring to FIGS. 1-7, the canopy assembly generally comprises a canopy 6 that is held taut by lateral rods 10, a front spreader bar 14, and a rear spreader bar 18. In one embodiment, a front edge 22 of the canopy 6 is interconnected to the front spreader bar 14 by at least one tensioner 26, and a rear edge 30 of the canopy 6 is interconnected to the rear spreader bar 18 by at least one tensioner 26. The lateral rods 10 are interconnected on one end to the front spreader bar 14 and on an opposite end to the rear spreader bar 18. The ends of the lateral rods 10 I received within cavities, holes, or indentations provided in the front and rear spreader bars. In this fashion, the canopy 6 is tensioned along a longitudinal axis 34 and a transverse axis 38 thereof.

The tension in the two lateral rods along with the shaped canopy material creates a uniquely shaped canopy for covering and protecting the cyclist. More specifically, the tensile pressure created by the configuration of the two lateral rods and the material, and overall shape of the canopy, allows the canopy assembly to resist wind shear and unnecessary movement. This configuration also provides a taller, wider canopy that is located well above a cyclist's head to provide protection from elements without obscuring the visibility. The configuration of the canopy, lateral rods, front spreader bar, and rear spreader bar also provides a wide shading surface positioned above a cyclist's head to provide better protection from the sun and other elements. The canopy assembly may be adjustable for use with different wheeled vehicles, such as a recumbent tricycle or tricycle, or to better suit the cyclist's preferences. For example, the front torsion bar can be replaced by two cables that pull the canopy towards the handlebars.

The canopy 6 is supported above the bicycle 2 by a front torsion bar 42 and two rear torsion bars 46. The front torsion bar 42 is interconnected to a midpoint of the front spreader bar 14 at a bushing block 50, which fixes the position of the front torsion bar 42 but allows it to rotate therein. This functionality prevents binding of the front torsion bar, which in turn ensures the canopy bows as intended. The opposite end of the front torsion bar 42 is interconnected to a front mount 54 associated with the bicycle's handlebar stem 58. Similarly, the rear torsion bars 46 are interconnected to the rear spreader bar 18 on one end and to a rear mount 62 on their opposite ends. The front and rear torsion bars are made of a rigid, yet bendable material such that when interconnected to the bicycle the spreader bars will bow the interconnected lateral rods 10, which maintains the desired canopy tension.

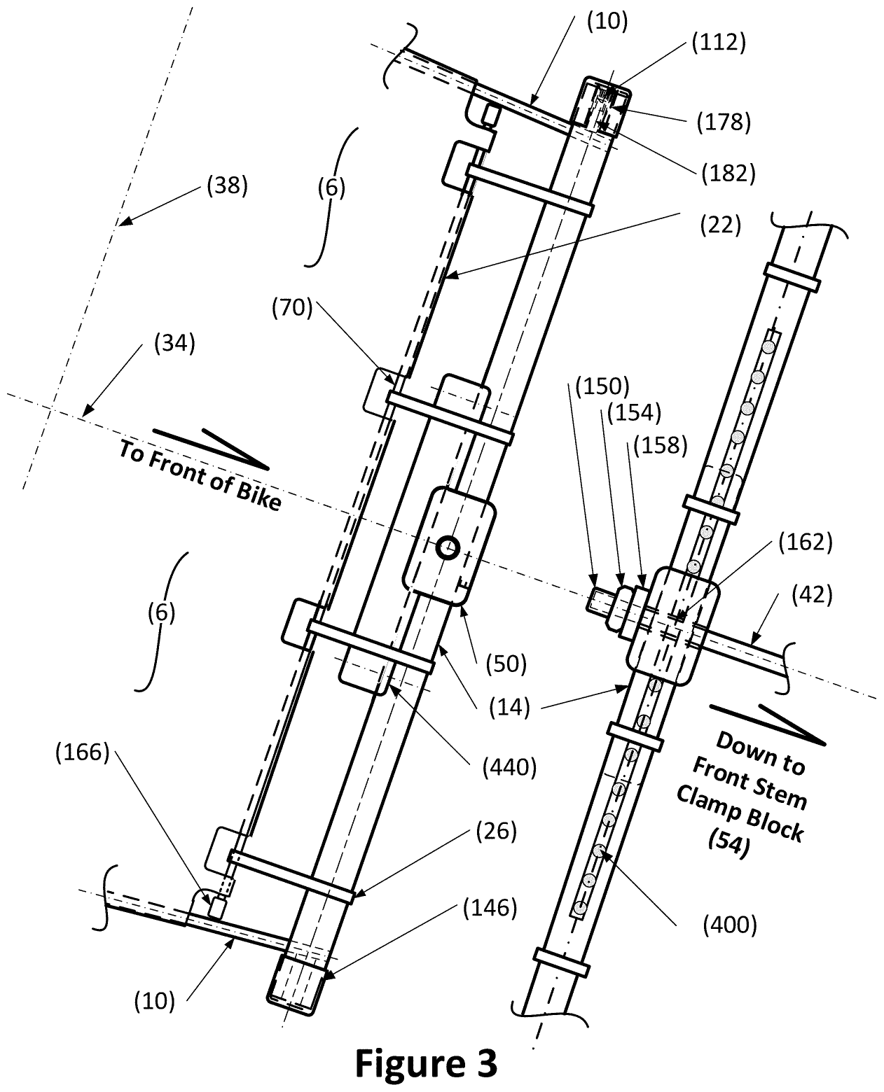

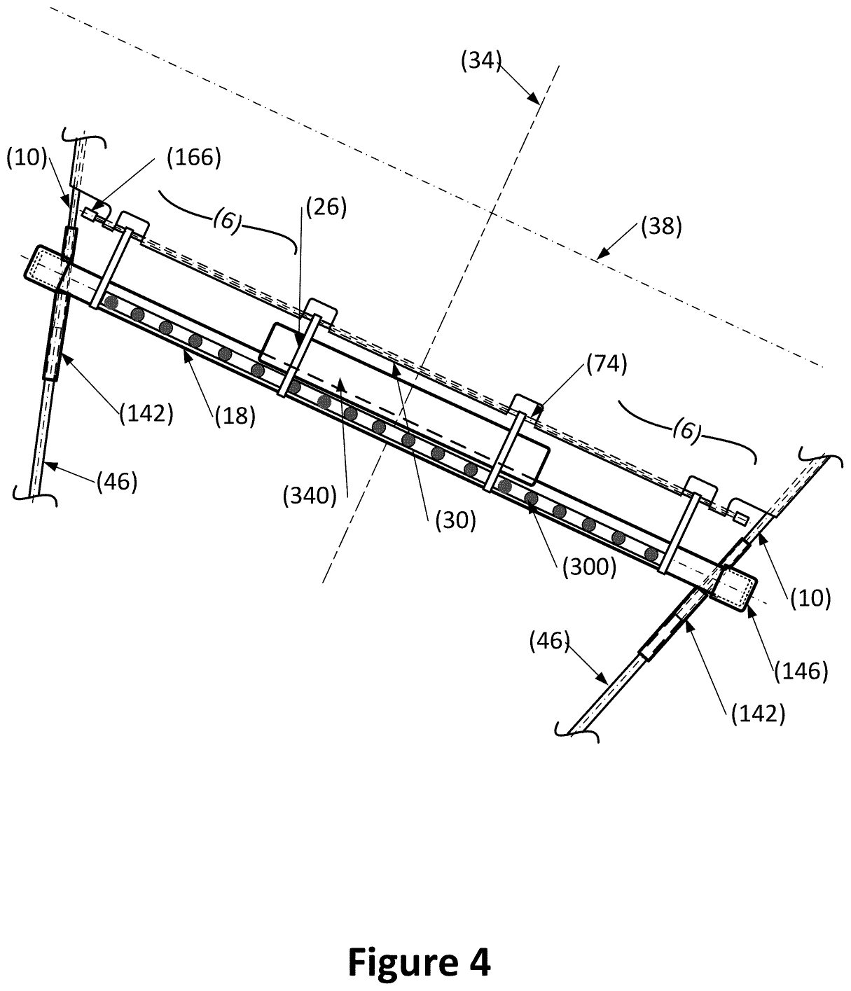

FIGS. 3 and 4 illustrate how the front edge 22 and the rear edge 30 of the canopy 6 of one embodiment of the present invention interconnect to their respective spreader bars. Here, a front tension rod 70 is associated with the front edge 22 of the canopy 6. Similarly, a rea tension rod 74 is associated with the rear edge of the canopy 6. The front and rear edges provide openings that receive one end of a tensioner 26, wherein the second end is interconnected to the spreader bar. FIG. 3 additionally shows how the front spreader bar 14 includes an opening or channel therethrough that receives ends of the lateral rods. The front spreader bar may include one or more holes positioned to receive the two lateral rods and, along with nylon inserts and set screws (or equivalent fixtures), apply pressure to secure the lateral rods in place. In embodiments, the front spreader bar houses a cross-drilled and bushed hole that functions to facilitate the equipment's steerability, and also contributes to the overall tension and design characteristics of the canopy. Again, the front torsion bar is interconnected to the front spreader bar by way of a coupling 50. That is, the front torsion bar is inserted through a bushing (or equivalent) in the front spreader bar and may be retained by a collet. This assembly is held in place by the front mount.

As shown in FIG. 4, the opposite ends of the lateral rods are received within openings through the rear spreader bar 18, such that the rear torsion bar is directly interconnected. Stated differently, the rear ends of the lateral rods can interconnect directly to corresponding rear torsion bars, or the lateral rods and rear torsion bars may be formed of an integral unit. In another embodiment of the present invention, the lateral rods and rear torsion bars interconnect to different locations on the rear spreader bar.

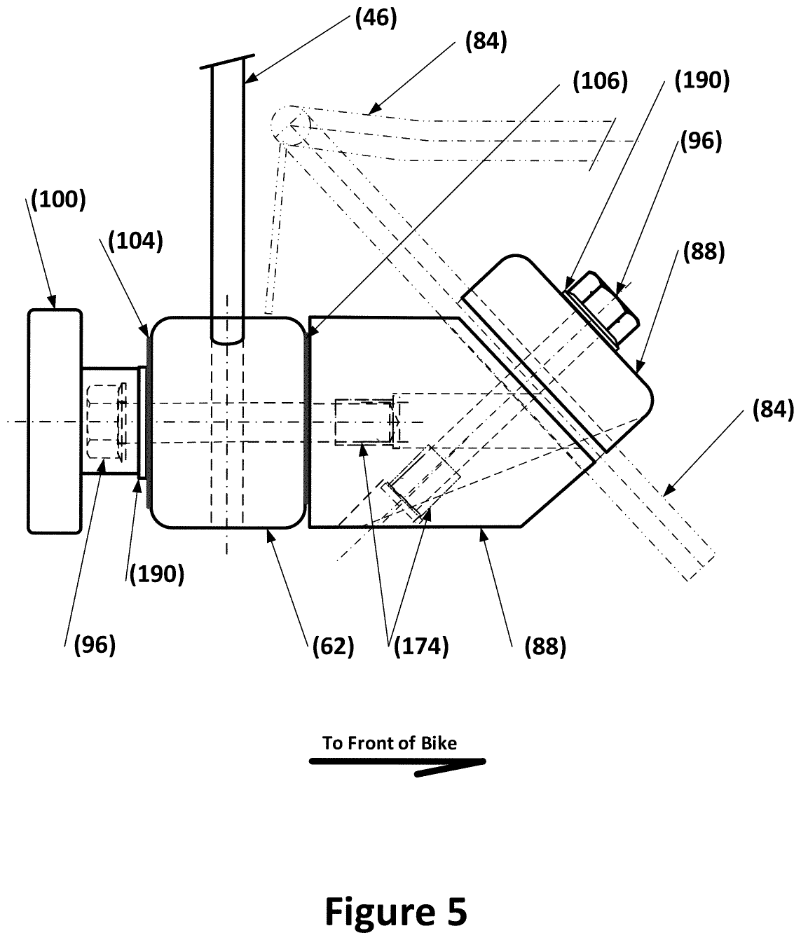

FIGS. 5-7 illustrate how ends of the rear tension bars 46 are associated with the bicycle. The embodiments shown herein are designed to interconnect with a rear bicycle rack 80, e.g., racks used to support a rear-mounted basket. Such racks are very common and very include a plurality of support members 84 that extend to a hub positioned near an axle of the rear bike tire. Here, a block 88 is interconnected to a clamp block 92 with at least one fastener 96. The block 88 and clamp 90 to grasp a portion of the bike rack. Those of ordinary skill in the art will appreciate that bike rack configurations vary and the clamp block 92, i.e. the member that secures the rear mount 62, can assume various shapes to accommodate different rack configurations without departing from the scope of the invention. The rear mount 62 is interconnected to the clamp block 92 with a fastener that is tightened with a hand knob 100 that allows the rear mount 62 to be removed from the clamp block 92 easily.

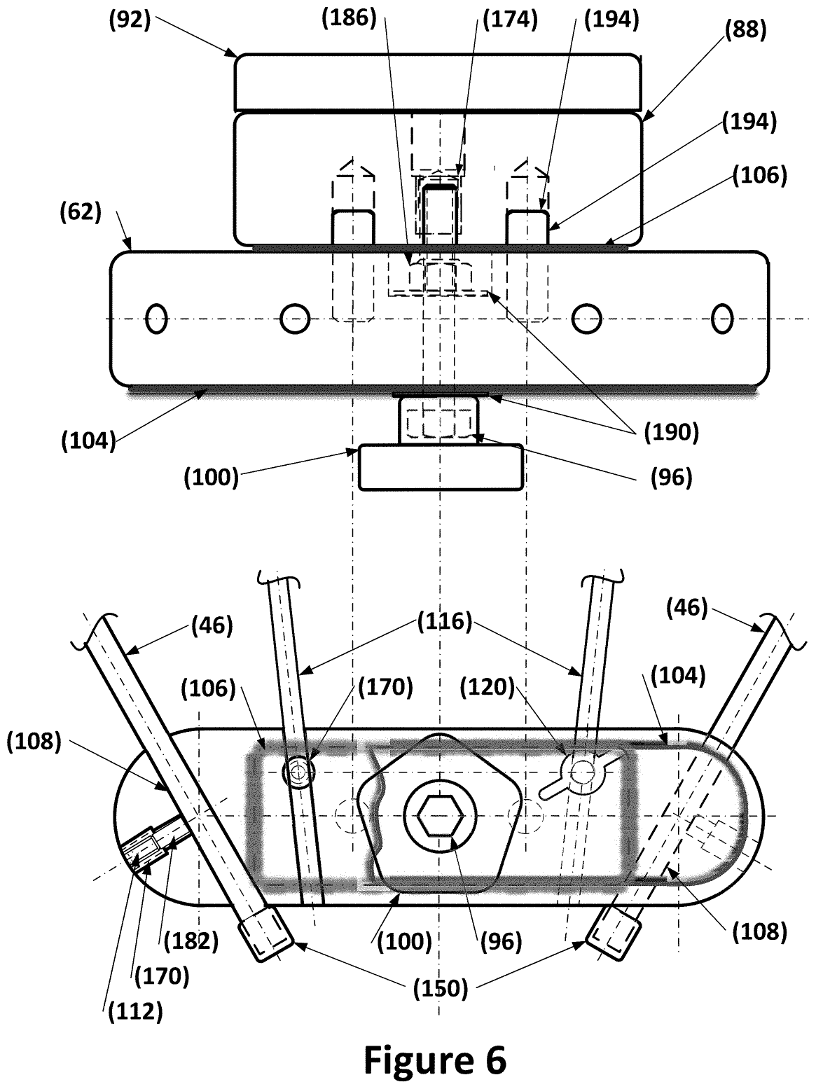

FIG. 6 is a front elevation view of the rear mount 62 that may include a reflective surface 104. The rear mount 62 includes a plurality of receivers 108, i.e. channels or cavities that accept the rear torsion bars 46, which are held in place with, for example, set screws 112. Additional receivers can be employed that accept a flag post 116, which is held in place by a thumb knob 120.

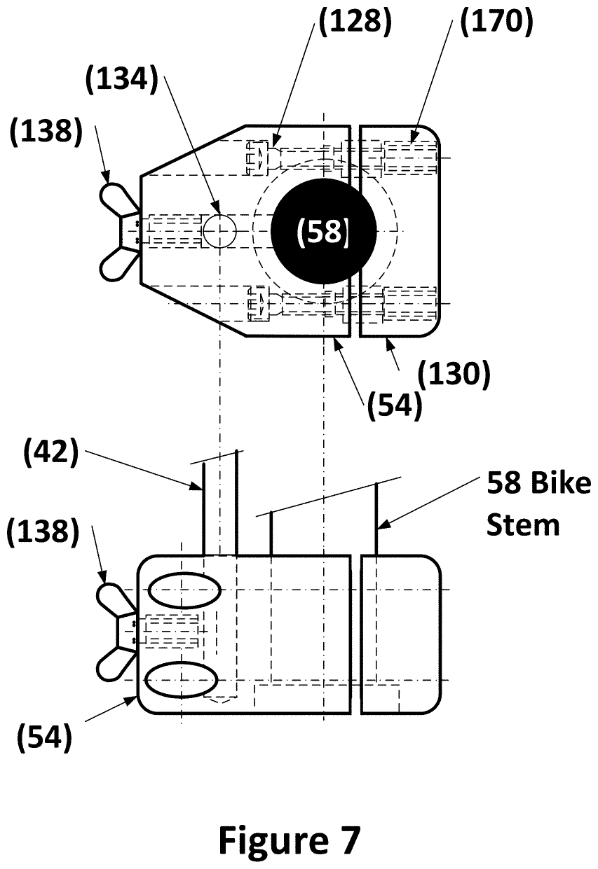

FIG. 7 shows the front mount 54 employed by some embodiments the present invention that is interconnected to a clamp block 130 with a handlebar stem 58 position therebetween. The front mount 54 includes receiver 134 that accepts one end of the front torsion bar, which is secured by a fastener that is loosened and tightened by a knob 138.

In one embodiment, the canopy assembly is designed for use with a “townie” style bicycle, such as an Elektra® townie bicycle. In these embodiments, while the assembly may share parts with assemblies for use with other equipment (such as a recombinant trike style piece of equipment); certain mounting components will be different, while other components are shared.

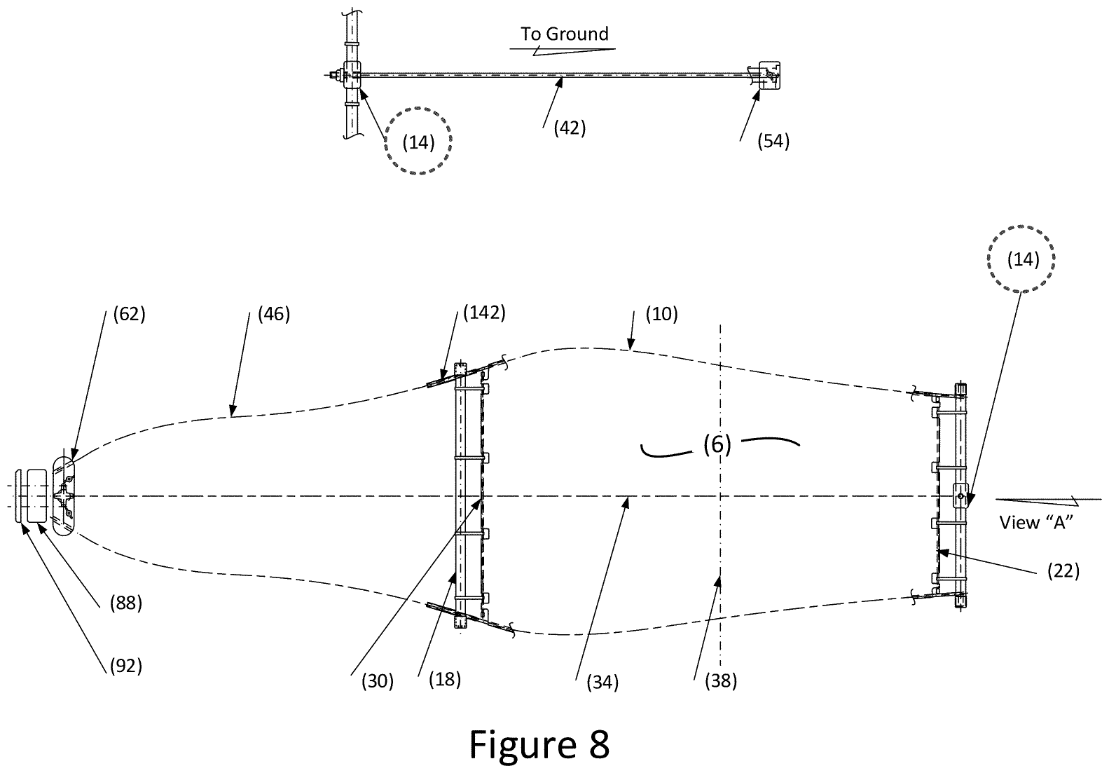

Referring now to FIG. 8, additional aspects of the canopy assembly for use with a two-wheel bicycle are illustrated. Reference is made to the various components of the assembly described above.

One embodiment of the present invention is for use with a recombinant trike, wherein the canopy assembly has been slightly modified to accommodate the differences in structure between the “townie” style bicycle and the trike style. To illustrate one of the differences, the front mount may be positioned on a tricycle's front derailleur stub adjacent the forward wheel of the recombinant trike, as opposed to against the handle bar stem.

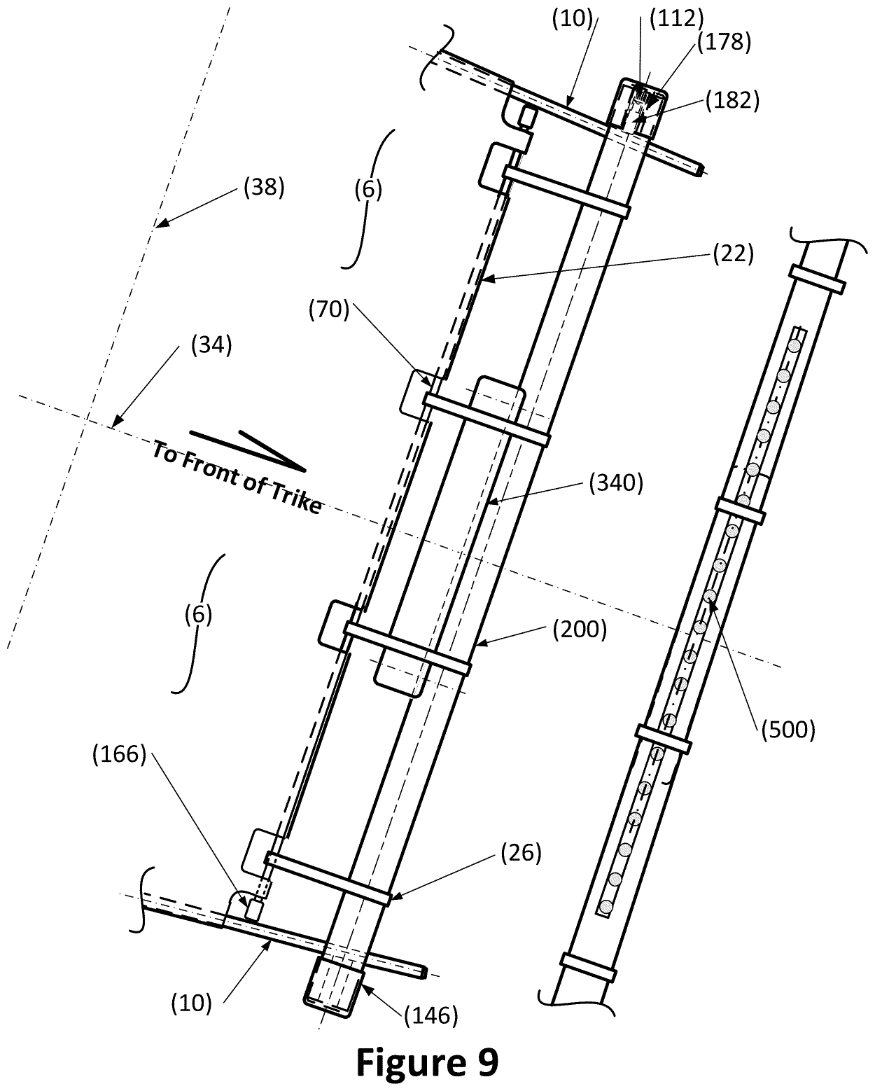

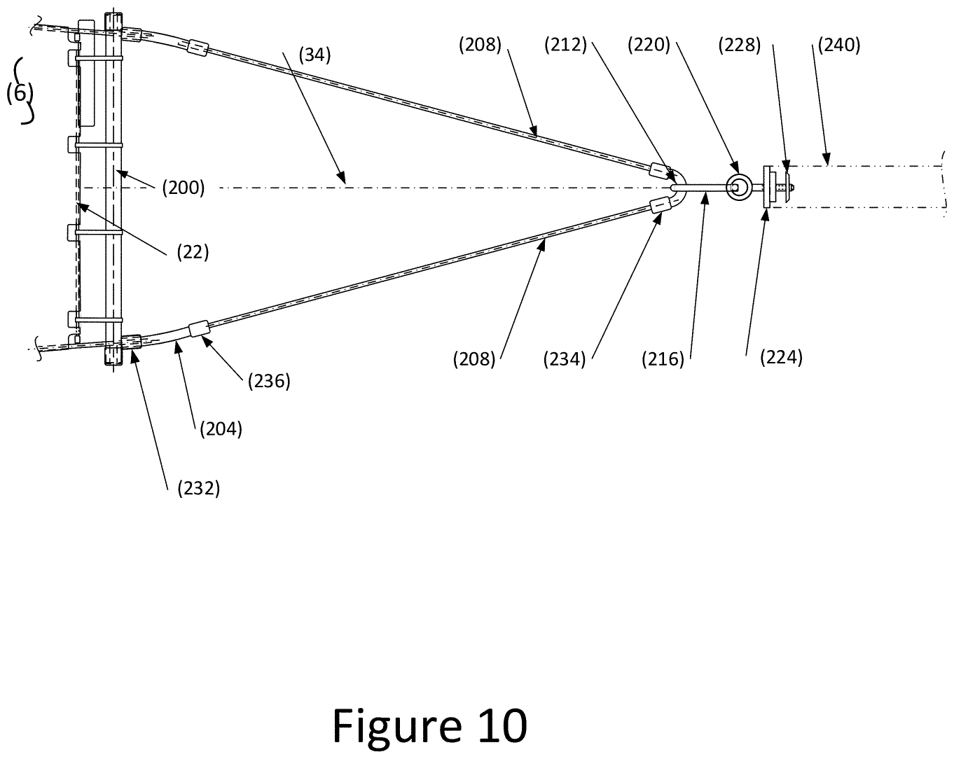

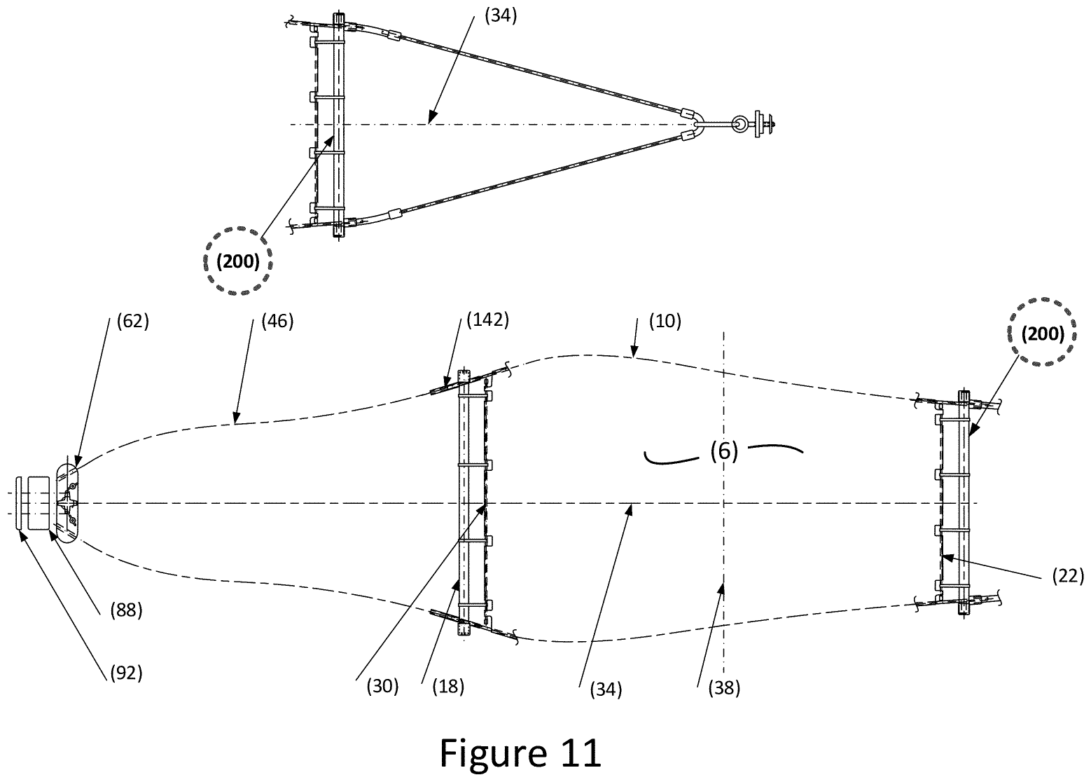

Referring to FIGS. 9-11, multiple views of a canopy assembly are shown for use with a recombinant trike style apparatus. Various components are represented by reference in the drawings, including common elements described in greater detail above in connection with FIGS. 1-8. Particular attention is drawn to the Derailleur Stub 240 and associated assembly of FIG. 10. In this view, the front of the “trike” is to the right hand portion of the assembly, and the components include a Front Rod 208 and Sleeve 234 coupled to a Lower Flex Coupler 212 and thereby to a Carabineer 216 or equivalent. The Carabineer 216 is in turn fastened to a Bolt 220 coupled by a Cap 224 and Expandable Nut 228, which affixes the assembly to the Derailleur Stub 240. Additional aspects of this embodiment are shown in FIG. 11.

One having skill in the art will appreciate that embodiments of the present invention may have various sizes. The sizes of the various elements of embodiments of the present invention may be sized based on various factors including, for example, the type of cycling equipment used with the assembly, the size and style of the cycling equipment, and other dimensional variations including, for example, width, length and thickness, and the size of the associated components of the cycling equipment.

One having skill in the art will appreciate that embodiments of the present invention may be constructed of materials known to provide, or predictably manufactured to provide the various aspects of the present invention. These materials may include, for example, stainless steel, titanium alloy, aluminum alloy, chromium alloy, other metals or metal alloys, carbon fiber, ABS plastic, polyurethane, polyethylene, photo-polymers, resins, particularly fiber-encased resinous materials such as fiberglass, rubber, latex, synthetic rubber, synthetic materials, polymers, wood, and natural materials.

While various embodiments of the present invention have been described in detail, it is apparent that modifications and alterations of those embodiments will occur to those skilled in the art. It is to be expressly understood that such modifications and alterations are within the scope and spirit of the present invention, as set forth in the following claims. Further, it is to be understood that the invention(s) described herein is not limited in its application to the details of construction and the arrangement of components set forth in the preceding description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

What is claimed is:

1. A canopy system, comprising:
an opaque or semi-opaque member having a front edge, a rear edge, a first lateral edge, and a second lateral edge, the first lateral edge and the second lateral edge interconnecting the front edge to the rear edge;
a first lateral rod interconnected to the first lateral edge;
a second lateral rod interconnected to the second lateral edge;
a front spreader bar associated with the front edge;
a second spreader bar associated with the rear edge, the front spreader bar and the second spreader bar configured to receive ends of the first lateral rod and the second lateral rod, which is configured to tension the opaque or semi-opaque member along a transverse axis thereof;
a front mount adapted to interconnect to a handle bar stem of a bike;
a rear mount interconnected to a clamp configured to interconnect to a block with a portion of a rear bike rack therebetween, the clamp having a first receiver and the rear mount having a second receiver and a third receiver;
a front torsion member interconnecting the front spreader bar to the first receiver;
a first rear torsion bar interconnecting the rear spreader bar to the second receiver;
a second rear torsion bar interconnecting the rear spreader bar to the third receiver; and
wherein the front torsion member, the first rear torsion bar, and the second rear torsion member are configured to tension the opaque or semi-opaque member generally along a longitudinal axis thereof.

2. The canopy system of claim 1, wherein the front torsion member is a bar and the receiver is a cavity in the clamp of the front mount that accepts an end of the rod opposite the front spreader bar.

3. The canopy system of claim 1, wherein the front torsion member is comprised of a first cable and a second cable that interconnect ends of the front spreader bar to the first receiver.

4. The canopy system of claim 1, wherein the rear mount includes a reflective surface.

5. The canopy system of claim 1, wherein the rear mount includes at least one of a light, a speaker, and a battery.

6. The canopy system of claim 1, wherein the rear mount is selectively interconnectable to the associated clamp.

7. The canopy system of claim 1, wherein the rear mount includes a third receiver configured to accept a flag post or light stick.

8. The canopy system of claim 1, wherein at least one of the front spreader bar and the second spreader bar have at least one light.

9. The canopy system of claim 1 further comprising a plurality of light elements.

10. The canopy system of claim 9, wherein the plurality of light elements are selectively controllable.

11. The canopy system of claim 1, wherein the first rear torsion rod and the second rear torsion rods employ integrated lights.

12. The canopy system of claim 1, wherein the front edge of the opaque or semi-opaque member is interconnected to the front spreader bar and the rear edge of the opaque or semi-opaque member is interconnected to the rear spreader bar.

13. The canopy system of claim 1, wherein the front torsion member, the first rear torsion member, and the second torsion member are segmented and selectively collapsible or foldable.

14. The canopy system of claim 1, wherein at least one of the front torsion member, the first rear torsion member, and the second torsion member hollow with at least one wire positioned therein.

15. The canopy system of claim 1, further comprising a second member spanning between the first rear torsion bar and the second rear torsion bar.

16. A canopy system, comprising:
a member having a front edge, a rear edge, a first lateral edge, and a second lateral edge, the first lateral edge and the second lateral edge interconnecting the front edge to the rear edge;
a first lateral rod interconnected to the first lateral edge;
a second lateral rod interconnected to the second lateral edge;
a front spreader bar associated with the front edge;
a second spreader bar associated with the rear edge, the front spreader bar and the second spreader bar configured to receive ends of the first lateral rod and the second lateral rod;
a front mount adapted to interconnect to a handle bar stem having a first receiver;
a rear mount adapted to interconnect to a block with a portion of a rear bike rack therebetween, the rear mount having a second receiver and a third receiver;
a front torsion bar interconnecting the front spreader bar to the first receiver;
a first rear torsion bar interconnecting the rear spreader bar to the second receiver; and
a second rear torsion bar interconnecting the rear spreader bar to the third receiver.

17. The canopy system of claim 16, wherein the rear mount includes at least one of a light, a speaker, and a battery.

18. The canopy system of claim 16, wherein the rear mount includes a third receiver configured to accept a flag post or light source.

19. The canopy system of claim 16, wherein at least one of the front spreader bar and the second spreader bar have at least one light.

20. The canopy system of claim 16, wherein the member has a plurality of light elements.
